(19) United States
(12) Patent Application Publication
(10) Pub. No.: US 2012/0177973 A1
(43) Pub. Date: Jul. 12, 2012

(54) ELECTROCHEMICAL ENERGY STORAGE AND METHOD FOR COOLING OR HEATING AN ELECTROCHEMICAL ENERGY STORAGE

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/384,984

(22) PCT Filed: Jul. 22, 2010
(86) PCT No.: PCT/EP10/04502

§ 371 Date: Mar. 28, 2012

(30) Foreign Application Priority Data
Jul. 24, 2009 (DE) 10 2009 034 675.9

(51) Int. Cl. H01M 10/50; F28D 15/00

(52) U.S. Cl. 429/120; 165/104.33; 165/104.11

(57) ABSTRACT

An electrochemical energy storage 101 comprises at least two electric current collectors 105, 106 for electrically connecting the electrochemical energy storage within an application environment. Said current collectors comprise a first region 103, 104 arranged within the electrochemical energy storage and a second region 105, 106 arranged outside of the electrochemical energy storage. The electrochemical energy storage according to the invention is characterized in that at least one of said electric current collectors is designed such that a liquid or gaseous heat transport medium 107, 108 can flow therethrough in the second region 105, 106.

The present invention relates to an electrochemical energy storage and a method for cooling or heating an electrochemical energy storage, in particular a lithium-ion accumulator battery. Such electrochemical energy storages are used, for example, in motor vehicles. The invention can also be used in electrochemical energy storages without lithium and also independently of motor vehicles, however.

Numerous constructions of electrochemical energy storages having galvanic cells for storing electrical energy are known from the prior art. Electrical energy supplied to such an energy storage is converted into chemical energy and stored. This conversion is subject to loss, because irreversible chemical reactions occur during this conversion, which cause aging of the accumulator battery. The occurring energy losses are released in the form of heat, which can be connected to a temperature increase of the galvanic cell.

In addition to more rapid conversion of the energy, however, the aging is also accelerated with increasing temperature within a galvanic cell of an accumulator battery. In particular during the acceleration of an electrically driven motor vehicle, high electrical currents are withdrawn from the accumulator battery over short periods of time. These high electrical currents also occur, for example, if the deceleration of a motor vehicle is supported by electrical devices and the obtained energy is supplied to the accumulator battery.

If the temperature in the galvanic cell rises excessively, the danger of destruction of the energy storage exists, this storage being able to burn or explode under certain conditions. Such undesired phenomena can be avoided by the most effective possible cooling of the electrochemical energy storage.

On the other hand, many electrochemical energy storages only work efficiently or reliably above a lower operating temperature, which is dependent on their construction and their operating principle. Therefore, depending on the intended purpose or the application of an electrochemical energy storage, it can be desirable to increase its temperature by supplying heat.

DE 602 134 74 T2 describes an electrochemical energy storage unit having a deformable, heat-conducting cooling bellows, which is joined to a serpentine arrangement and has multiple flow compartments, through which a heat transfer medium flows.

DE 699 01 973 T2 describes a battery made of multiple cells having a housing, a ventilation system, and a metallic heat sink, and a fluid conduction means, which conducts the air to the cells.

DE 10 2007 012 893 A1 describes a cooling device for batteries having storage cells, which are housed in a battery box and have a cooling apparatus for cooling the cells. For cooling which meets the demand, it is proposed that the cooling device comprise an air heat exchanger, a liquid radiator, and a three-way valve for changing over between these two coolers on demand.

The present invention is therefore based on the object of specifying the most effective possible method for cooling and/or heating an electrochemical energy storage and a corresponding electrochemical energy storage. This is achieved according to the invention by the subjects of the independent claims.

The electrochemical energy storage according to the invention has at least two electrical current collectors for electrically connecting the electrochemical energy storage inside an application environment. These current collectors have a first region arranged inside the electrochemical energy storage and a second region arranged outside the electrochemical energy storage. The electrochemical energy storage according to the invention is characterized in that at least one of these electrical current collectors is designed so that a liquid or gaseous heat transport medium can flow through it in the second region.

In the method according to the invention for cooling or heating such an electrochemical energy storage, at least one of the electrical current collectors of the energy storage has a liquid or gaseous heat transport medium flowing through it in the second region.

In the context of the description of the present invention, an electrochemical energy storage is to be understood as any type of energy storage from which electrical energy can be withdrawn, an electrochemical reaction running in the interior of the energy storage. The term particularly comprises galvanic cells of all types, in particular primary cells, secondary cells, and interconnections of such cells to form batteries made of such cells. Such electrochemical energy storages typically have negative and positive electrodes, which are separated by a so-called separator. Ion transport occurs between the electrodes through an electrolyte.

In the context of the description of the present invention, a current collector is to be understood as an electrically conductive structural element of an electrochemical energy storage, which is used to transport electrical energy into the energy storage or out of the energy storage. Electrochemical energy storages typically have two types of current collectors, which are each connected to one of the two groups of electrodes—anodes or cathodes—in the interior of the energy storage.

In the context of the description of the present invention, a heat transport medium is to be understood as a gaseous or liquid material, which is capable because of its physical properties of transporting heat by heat conduction and/or heat transport via aerodynamic or hydrodynamic currents, in particular also convective currents, in the heat transport medium. Important examples for heat transport media generally used in technology are, for example, air or water or other typical coolants. Depending on the application context, other gases or liquids are also typical, such as chemically inert (less reactive) gases or liquids, such as noble gases or liquefied noble gases or materials having high heat capacity and/or high heat conductivity.

In the context of the description of the present invention, an application environment of an energy storage is to be understood as any technical device which is or can be electrically connected to the energy storage and therefore can withdraw electrical energy from the energy storage or can supply electrical energy to the energy storage. Examples of such application environments are electrical consumers of all types or electrical energy supply devices or combinations of electrical consumers and suppliers.

Advantageous embodiments and refinements are the subject matter of the subclaims.

A preferred electrochemical energy storage has at least one current collector, which is designed so that a liquid or gaseous heat transport medium can also flow through it in the first region. In this embodiment of the invention, the heat transport is also caused in the first region by a cooperation of heat conduction and heat transport through convection currents in the heat transport medium and therefore is possibly further improved upon suitable selection of a heat transport medium.

A particularly preferred electrochemical energy storage has at least one current collector, which is designed so that the same liquid or gaseous heat transport medium can flow through it in the first region and in the second region. This embodiment is particularly simple to implement and can possibly be connected with particularly effective heat transport upon suitable selection of a heat transport medium.

A particularly preferred electrochemical energy storage has at least one current collector, which is designed so that a first liquid or gaseous heat transfer medium can flow through it in the first region and a second liquid or gaseous heat transport medium can flow through it in the second region. Upon suitable selection of the heat transport media and/or upon suitable design of the flow conditions, this embodiment can possibly be connected with particularly effective heat transport. This is true in particular if, according to a particularly preferred embodiment of the present invention, at least one current collector is designed so that a heat exchange can occur between the first heat transport medium and the second heat transport medium.

A further preferred electrochemical energy storage has at least one current collector, which is connected in a second region to a cooling body in a heat-conducting manner. By attaching a cooling body to the current collector, through which a heat transport medium flows, the heat transport can be further improved.

In a further preferred electrochemical energy storage, at least one cooling body is designed so that a liquid or gaseous heat transfer medium can flow at least partially around it. This additional measure of this exemplary embodiment may also be connected with a further improvement of the heat transport in many cases.

In a preferred method according to the invention, at least one current collector also has a liquid or gaseous heat transport medium flowing through it in the first region. In this embodiment of the invention, the heat transport is also caused in the first region by cooperation of heat conduction and heat transport by convection currents in the heat transport medium and is therefore possibly further improved upon suitable selection of a heat transport medium.

In a particularly preferred method according to the invention, the same liquid or gaseous heat transport medium flows through at least one current collector in the first region and in the second region. This embodiment is particularly simple to implement and can possibly be connected with particularly effective heat transport upon suitable selection of a heat transfer medium.

In a particularly preferred method, a first liquid or gaseous heat transport medium flows through at least one current collector in the first region and a second liquid or gaseous heat transport medium flows through at least one current collector in the second region. Upon suitable selection of the heat transport media and/or upon suitable design of the flow conditions, this embodiment can possibly be connected with particularly effective heat transport. This is true in particular if, according to a particularly preferred embodiment of the present invention, at least one current collector is designed so that a heat exchange can occur between the first and the second heat transport media.

In a further preferred method, at least one current collector is connected in the second region to a cooling body in a heat-conducting manner. The heat transport can be improved further by attaching a cooling body to the current collector, through which a heat transfer medium flows.

In a particularly preferred method, a liquid or gaseous heat transfer medium at least partially flows around at least one cooling body. This additional measure of this exemplary embodiment may also be connected with further improvement of the heat transport in many cases.

A person skilled in the art will know to combine some of the described embodiments of the present invention on the basis of his knowledge in the art; a person skilled in the art will easily find other advantageous exemplary embodiments, which cannot be described exhaustively here, on the basis of his knowledge in the art. The invention is not restricted to the exemplary embodiments described here.

The invention is described in greater detail hereafter on the basis of preferred exemplary embodiments and with the aid of the figures.

In the figures:

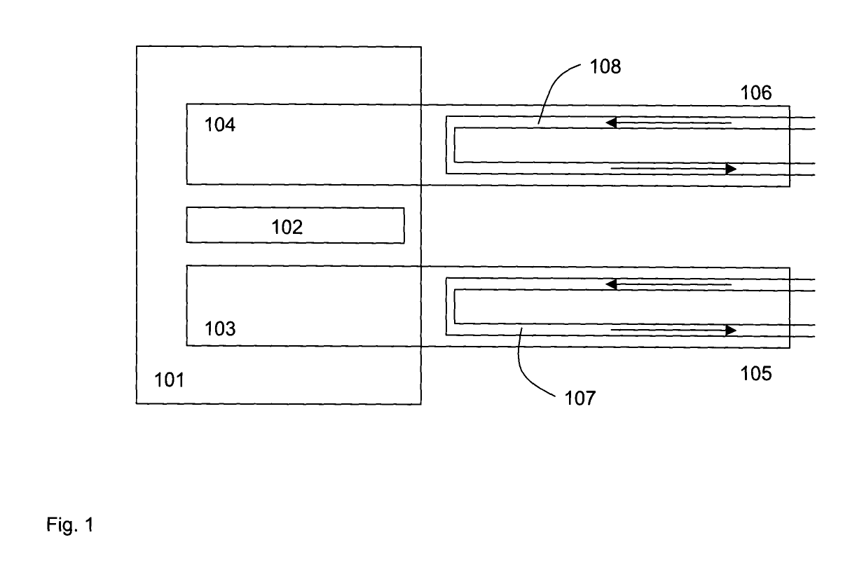

FIG. 1 shows a schematic view of an electrochemical energy storage according to the invention according to a first embodiment of the present invention, in which a heat transport medium only flows through two current collectors in the region outside the energy storage.

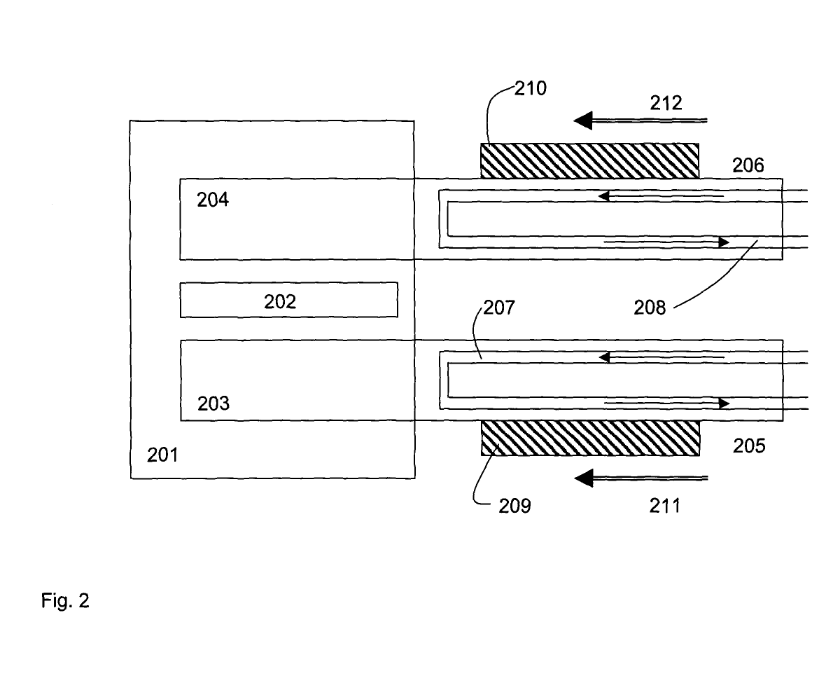

FIG. 2 shows a schematic view of an electrochemical energy storage according to the invention according to a second embodiment of the present invention, in which a heat transfer medium only flows through two current collectors in the region outside the energy storage, and in which both current collectors are in contact with a cooling body.

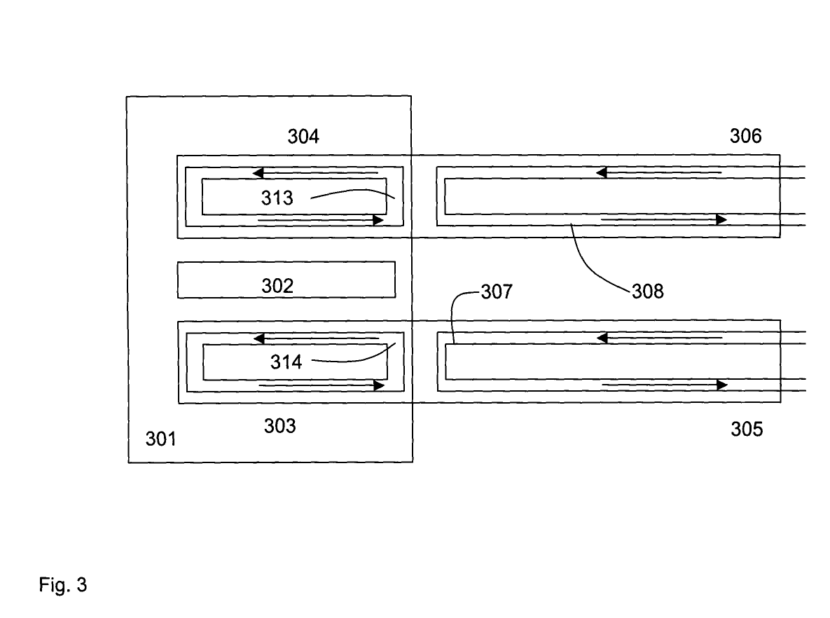

FIG. 3 shows a schematic view of an electrochemical energy storage according to the invention according to a third embodiment of the present invention, in which a first heat transport medium flows through two current collectors in the region inside the energy storage and a second heat transport medium flows through two current collectors in the region outside the energy storage.

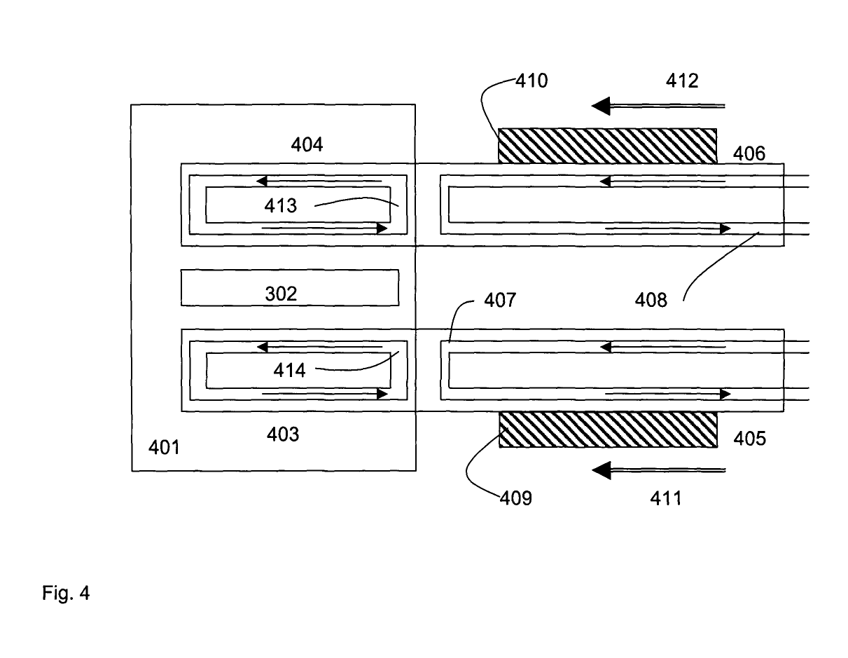

FIG. 4 shows a schematic view of an electrochemical energy storage according to the invention according to a fourth embodiment of the present invention, in which a first heat transfer medium flows through two current collectors in the region inside the energy storage and a second heat transport medium flows through two current collectors in the region outside the energy storage, and in which both current collectors are in contact with a cooling body.

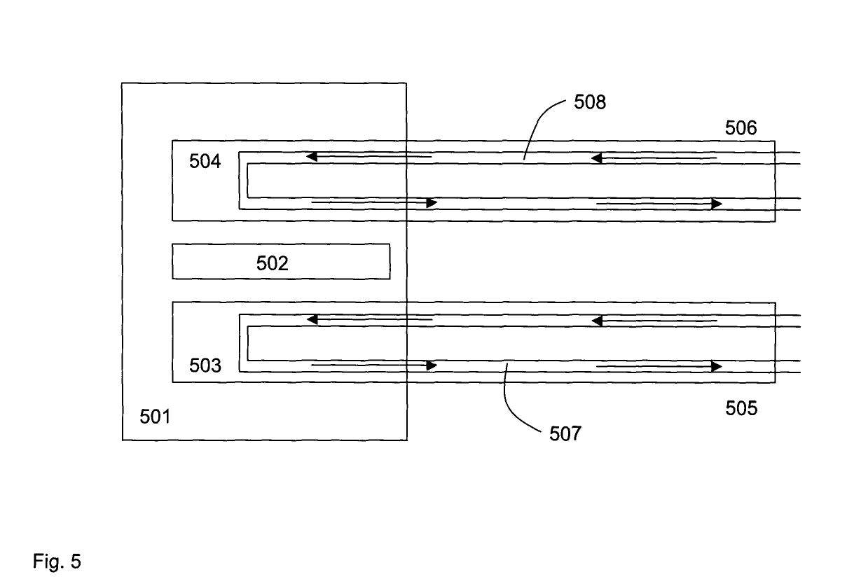

FIG. 5 shows a schematic view of an electrochemical energy storage according to the invention according to a fifth embodiment of the present invention, in which the same heat transport medium flows through two current collectors in the region inside and in the region outside the energy storage.

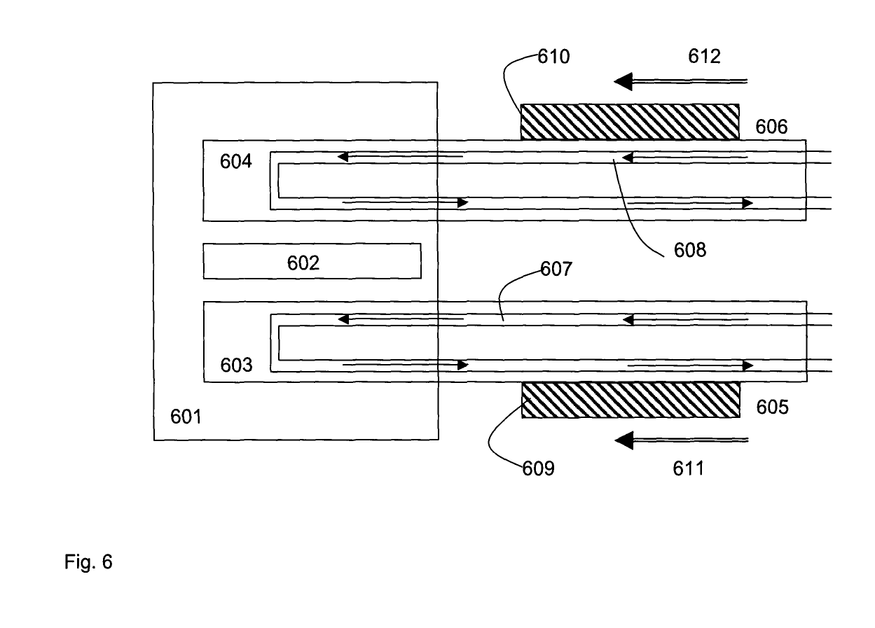

FIG. 6 shows a schematic view of an electrochemical energy storage according to the invention according to a sixth embodiment of the present invention, in which the same heat transport medium flows through two current collectors in the region inside and in the region outside the energy storage, and in which both current collectors are in contact with a cooling body.

An electrochemical energy storage according to the invention preferably has current collectors which conduct heat well. Such current collectors conduct the electrical current out of this galvanic cell or into it. Such current collectors are preferably metallic and therefore, in addition to sufficient electrical conductivity, frequently also already have high thermal conductivity.

This high thermal conductivity has the effect that only slight temperature gradients occur inside a current collector and high heat flows can be conducted into or out of the galvanic cell. A first region 103, 104, 203, 204, 303, 304, 403, 404, 503, 504, 603, 604 of the current collector is arranged inside a galvanic cell and electrically connected therein to the electrochemically active components of the galvanic cell, i.e., to the electrodes, which are separated by a separator 102, 202, 302, 402, 502, 602, of opposite poles. A second region 105, 106, 205, 206, 305, 306, 405, 406, 505, 506, 605, 606 of the current collector extends out of this galvanic cell and is used for the purpose of electrically connecting the energy storage to the application environment.

As schematically shown in FIG. 1 on the basis of an exemplary embodiment, an electrochemical energy storage has at least two electrical current collectors, which are used for the electrical connection of the electrochemical energy storage inside an application environment. These current collectors have a first region arranged inside the electrochemical energy storage and a second region arranged outside the electrochemical energy storage. It is provided according to the invention that at least one of these electrical current collectors is designed so that a liquid or gaseous heat transport medium 107, 108, 207, 208, 307, 308, 407, 408, 507, 508, 607, 608 can flow through it in the second region.

Flow ducts 107, 108, 207, 208, 307, 308, 407, 408, 507, 508, 607, 608 are preferably provided for this purpose in the current collector according to the invention, through which the liquid or gaseous heat transport medium can flow. In this way, the current collector is not exclusively cooled via the mechanism of heat conduction in this outer region, but rather heat transport additionally occurs with the aid of the liquid or gaseous heat transfer medium.

The flow of the heat transport medium can be driven by so-called convection, in which a temperature gradient forming in the current collector itself induces a convection current in the heat transport medium. This convection current ensures that the heat transport medium is continuously supplied at lower temperature to the outer region of the current collector, and the heat transfer medium is simultaneously removed at higher temperature from this current collector. If the material properties of the heat transport medium are suitably selected, more effective cooling may be achieved by a flowing heat transport medium than if the cooling were performed solely by heat conduction in a metallic current collector, for example.

Instead of inducing the heat transport in the heat transfer medium solely by thermal convection, it is also possible to drive the stream of the heat transport medium through the flow ducts from the outside. In this case, the flow velocity can be selected as greater than if solely thermal convection occurred. The externally applied flow velocity can be selected so that the achieved heat transport is adapted to the instantaneous requirements of the application or the operating state of the energy storage.

The device shown in FIG. 1 can be used for both cooling and also heating the electrochemical energy storage. For example, if the electrochemical energy storage is below its optimum operating temperature, by feeding a suitably heated heat transport medium into the flow channels of the current collector, the current collector can be heated in its outer region. A temperature gradient forms in the current collector, which is dissipated by heat conduction through a heat flow which begins in the direction toward the inner region. As a result, a heat flow of the heat transport medium thus occurs in the outer region of the current collector and inside the current collector by heat conduction from the outer region into its inner region, the inner region of the current collectors 103, 104 being heated, which can result overall in heating of the cell and therefore an increase of the temperature of the energy storage to its operating temperature.

In contrast, if heating occurs inside the energy storage in operation of the energy storage due to the progress of irreversible chemical reactions, then it must be frequently cooled to prevent the energy storage from heating beyond its maximum operating temperature. In this case, a cooling heat transport medium is fed at lower temperatures into the flow ducts 107, 108 of the outer regions 105, 106 of the current collectors. This results in cooling of the outer regions 105, 106 of the current collectors, whereby a temperature gradient results between the inner regions 103, 104 and the outer regions 105, 106. This temperature gradient is dissipated by the occurring heat conduction from the inner regions 103, 104 into the outer regions 105, 106 of the current collectors, whereby as a result a heat flow from the inside to the outside arises, whereby the cell and therefore the energy storage are cooled.

As schematically shown in FIG. 2 on the basis of a further exemplary embodiment, the heat transport, for example, in the case of cooling, can be improved further in that cooling bodies 209, 210, which are in good heat conducting contact with the current collectors, are attached in the outer regions 205, 206 of the current collectors. Through such cooling bodies, which preferably have a large surface area and therefore can significantly increase the heat transfer between the current collectors and the environment, the cooling of an electrochemical energy storage can be significantly improved in the operating state. This is all the more true if a heat transfer medium 211, 212 additionally flows around the cooling bodies 209, 210. This can be a gaseous heat transport medium, for example, air, or also a liquid heat transport medium, for example, water.

The selection of a suitable heat transport medium is influenced by various factors. On the one hand, the aspect of the most effective possible heat transfer is of great significance in the material selection. On the other hand, the employed energy storage technology can also influence the selection of a heat transport medium. It is thus generally advantageous if the selected heat transfer medium behaves chemically inert (less reactive) in relation to the materials with which it comes into contact in normal operation, or with which it could come into contact in case of malfunction.

As schematically shown in FIG. 3 on the basis of a further exemplary embodiment of the invention, the heat transfer between the interior of the electrochemical energy storage and the outer regions 305, 306 of the current collectors can be improved further if a heat transfer medium also flows through the inner regions of the current collectors 303, 304. In the exemplary embodiment which is schematically shown in FIG. 3, the heat transport medium flows through closed flow ducts 313, 314 in the inner regions 303, 304 of the current collectors. The arrangement shown here of the flow ducts in the inner regions of the current collectors therefore primarily contributes to dissipating temperature gradients within the inner regions 303, 304 of the current collectors. This arrangement of the flow ducts in the inner regions does not result in a heat transport through flow of a heat transport medium from the inner regions into the outer regions 305, 306 of the current collectors. For this reason, it is preferable in this exemplary embodiment to arrange the flow ducts 308 and 313 or 307 and 314 so that a more intensive heat exchange can occur between these flow ducts. This can preferably be achieved, inter alia, in that the current collectors are implemented having particularly good heat conduction in the transition region between the inner region of the current collectors 303, 304 and the outer region 305, 306 of the current collectors.

As schematically shown in FIG. 4 on the basis of a further exemplary embodiment, the heat transport, for example, in the case of the cooling, can also be improved further in the case of the exemplary embodiment shown in FIG. 3, in that cooling bodies 409, 410, which are in good heat conducting contact with the current collectors, are attached in the outer regions 405, 406 of the current collectors. Through such cooling bodies, which preferably have a large surface area and can therefore significantly increase the heat transfer between the current collectors and the environment, the cooling of an electrochemical energy storage in the operating state may be significantly improved. This is all the more true if a heat transport medium 411, 412 additionally flows around the cooling bodies 409, 410. This can be a gaseous heat transport medium, for example, air, or also a liquid heat transport medium, for example, water.

FIG. 5 schematically shows a further exemplary embodiment of the invention, in which he transport medium flowing in the outer regions 505, 506 of the current collectors also flows in the inner regions 503, 504 of these current collectors. Upon suitable selection of the material properties of the heat transport medium and upon suitable design of the flow ducts, the heat transport served by the flow of the heat transport medium will be particularly high in this embodiment.

In regard to the operational reliability of the entire device, however, it could be connected with difficulties—depending on the employed technology of the electrochemical energy storage—to have the same heat transport medium flowing in the inner region and in the outer region of the current collector, for example, if a heat transport medium which is very effective in the outer region could chemically react in an undesired way with the materials used in the interior of the energy storage in case of malfunction.

As shown schematically in FIGS. 4 and 6 on the basis of further exemplary embodiments, the heat transport through the current collectors can be improved further if suitably designed cooling bodies are arranged in heat-conducting contact with the current collectors in the outer region of the current collectors, which increase the heat transfer between the current collectors and the environment. This effect can be improved further if a heat transport medium flows around these cooling bodies.

The heat transport medium 611, 612 employed to cool the cooling bodies 609, 610 is preferably an electrical insulator, otherwise having the best possible heat transport properties. In many cases, air or a chemically inert gas such as nitrogen or carbon dioxide will appear suitable for this purpose. The flow of gaseous heat transport medium can preferably be driven by a suitable arrangement of fans. Pumps are preferably suitable for generating and maintaining a flow of liquid heat transport media. The power of such fans or pumps can preferably be a function of measured temperatures in the area of the current collectors, so that the power of these valves or pumps is increased, for example, if the temperature deviates excessively from the desired operating temperature. The employed heat transport media are to be temperature controlled suitably depending on whether cooling or heating of the interior of the electrochemical energy storage is required or desirable. This can preferably be performed via an electrical heater or via an electrically operated cooling assembly.

1. An electrochemical energy storage (101, 201, 301, 401, 501, 601) having at least two electrical current collectors (105, 106, 205, 206, 305, 306, 405, 406, 505, 506, 605, 606) for electrically connecting the electrochemical energy storage inside an application environment, these current collectors having a first region (103, 104, 203, 204, 303, 304, 403, 404, 503, 504) arranged inside the electrochemical energy storage and a second region (105, 106, 205, 206, 305, 306, 405, 406, 505, 506, 605, 606) arranged outside the electrochemical energy storage, characterized in that at least one of these electrical current collectors is designed so that a liquid or gaseous heat transport medium can flow through it (107, 108, 207, 208, 307, 308, 407, 408, 507, 508, 607, 608) in the second region (105, 106, 205, 206, 305, 306, 405, 406, 505, 506, 605, 606).

2. The electrochemical energy storage according to claim 1, having at least one current collector, which is designed so that a liquid or gaseous heat transport medium can also flow through it (313, 314, 413, 414, 507, 508, 607, 608) in the first region (303, 304, 403, 404, 503, 504, 603, 604).

3. The electrochemical energy storage according to claim 2, having at least one current collector which is designed so that the same liquid or gaseous heat transport medium can flow through it (507, 508, 607, 608, 313, 314, 413, 414) in the first region and in the second region (303, 304, 403, 404, 503, 504, 603, 604).

4. The electrochemical energy storage according to claim 2, having at least one current collector, which is designed so that a first liquid or gaseous heat transport medium (413, 414, 513, 514) can flow through it in the first region (403, 404, 503, 504) and a liquid or gaseous heat transport medium (407, 408, 507, 508) can flow through it in the second region (405, 406, 505, 506).

5. The electrochemical energy storage according to claim 4, having at least one current collector, which is designed so that a heat exchange can occur between the first and the second heat transport media.

6. The electrochemical energy storage according to one of the preceding claims, having at least one current collector, which is connected to a cooling body (209, 210, 409, 410, 609, 610) in a heat-conducting manner in the second region (205, 206, 405, 406, 605, 606).

7. The electrochemical energy storage according to claim 6, wherein at least one cooling body (209, 210, 409, 410, 609, 610) is designed so that a liquid or gaseous heat transport medium can flow at least partially around it (211, 212, 411, 412, 611, 612).

8. A method for cooling or heating an electrochemical energy storage having at least two electrical current collectors for electrically connecting the electrochemical energy storage inside an application environment, these current collectors having a first region arranged inside the electrochemical energy storage and a second region arranged outside the electrochemical energy storage, characterized in that a liquid or gaseous heat transport medium flows through at least one of these electrical current collectors in the second region.

9. The method according to claim 8, wherein at least one current collector also has a liquid or gaseous heat transport medium flowing through it in the first region.

10. The method according to claim 9, wherein the same liquid or gaseous heat transfer medium flows through at least one current collector in the first region and in the second region.

11. The method according to claim 9, wherein a first liquid or gaseous heat transport medium flows through at least one current collector in the first region and a second liquid or gaseous heat transfer medium flows through at least one current collector in the second region.

12. The method according to claim 11, wherein a heat exchange occurs between the first heat transport medium and the second heat transport medium.

13. The method according to one of the preceding claims, wherein at least one current collector is connected to a cooling body in a heat-conducting manner in the second region.

14. The method according to claim 13, wherein a liquid or gaseous heat transport medium at least partially flows around at least one cooling body.
